(19) United States
(12) Patent Application Publication
(10) Pub. No.: US 2012/0278113 A1
(43) Pub. Date: Nov. 1, 2012

(54) SYSTEM AND RELATED METHOD FOR EVENT RESERVATION

(75) Inventors: Reef R. Mowers, San Diego, CA (US); Bert W. Metcalf, San Diego, CA (US); Stephen P. Corgiat, El Dorado, CA (US)

(73) Assignee: Memo Entertainment Group Inc., San Diego, CA (US)

(21) Appl. No.: 13/094,063

(22) Filed: Apr. 26, 2011

(51) Int. Cl. G06Q 10/00

(52) U.S. Cl. 705/5

(57) ABSTRACT

A computer-based reservation system and method is provided, for event reservation such as bottle service at nightclubs. The system is configured to present to a user via digital communications with a client device, a listing of nightclubs in response to a reservation search received from the user. The reservation search can include location and date. The system provides the listing to include nightclubs within the requested location having availability on the requested date and pricing for bottle service. The system enables the user to select a nightclub from the list to secure a reservation. The system further configured to secure a bottle-service reservation for the user at a selected nightclub based upon terms to include date, price, and a bottle minimum, agreed upon by the user and the selected nightclub, in which reservation details are transmitted to the user and the selected nightclub via digital communications.

### FIELD OF THE INVENTION

The invention relates generally to event reservation systems and, more particularly, to an electronic system for reserving and sponsoring events such as bottle service at nightclubs.

### BACKGROUND OF THE INVENTION

Bottle service is an arrangement where the nightclub provides patrons who pay for the service with their own private table, booth, skybox, or VIP room, and the patrons can purchase complete bottles of their choice of alcohol accompanied with mixers, condiments, and ice, which are served tableside by a personal server. The purchase of bottle service often results in nightclub cover charges being waived for the purchaser's party and often allows the party to bypass entrance lines. Many nightclubs also offer transportation to the club for purchasers of bottle service.

Bottle service typically requires a two-bottle minimum for the table and has a three- to four-guest maximum per bottle, meaning a bottle must be purchased for every third or fourth person in the party. The cost of a bottle of alcohol and alcohol mixers is usually marked up significantly and can contribute significantly to an establishment's revenue. Additional fees can be applied. Some nightclubs charge a flat fee for the reservation of bottle service. Additionally, nightclubs automatically add gratuity, which can be upwards of 20%, to every VIP bottle service tab.

In order to reserve bottle service, patrons must call a nightclub directly or reserve the service through a club host or “promoter” who works with the club as an independent contractor. Many of these hosts and promoters also have websites through which consumers can make reservations for the clubs the host or promoter works with, but patrons do not have the opportunity to bargain for a price or easily compare prices between several nightclubs. In this way, nightclubs maintain one-sided negotiations on bottle service, as patrons cannot easily compare prices, bargain, or make educated choices on where they can purchase the best service for their money.

It should, therefore, be appreciated that there remains a need for a system that addresses the aforementioned shortcomings. The present invention fulfills this need and others.

### SUMMARY OF THE INVENTION

In general terms, the present invention provides a computer-based reservation system utilizing a method for event reservation such as bottle service at nightclubs. The system is configured to present to a user via digital communications with a client device, a listing of nightclubs in response to a reservation search received from the user. The reservation search can include location and date. The system provides the listing to include nightclubs within the requested location having availability on the requested date and pricing for bottle service. The system enables the user to select a nightclub from the list to secure a reservation. The system further configured to secure a bottle-service reservation for the user at a selected nightclub based upon terms to include date, price, and a bottle minimum, agreed upon by the user and the selected nightclub, in which reservation details are transmitted to the user and the selected nightclub via digital communications.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a simplified block diagram of a reservation system in accordance with the present invention.

FIG. 2 is an exemplary webpage of the system of FIG. 1, depicting options for reserving bottle service at a nightclub, sponsoring bottle service for others to join, and registering on a guest list for an event.

FIG. 3 is an exemplary webpage arrived at by selecting the “Reserving Bottle Service” option of the webpage of FIG. 2, depicting results from a search, listing of nightclubs providing bottle service in a selected area.

FIG. 4 is an exemplary webpage presenting details for an establishment selected from the listing on the webpage of FIG. 3.

FIG. 5 is an exemplary webpage for reserving bottle service at a nightclub, including an option enabling a user to modify or propose alternative packages to one or more establishments.

FIG. 6 is an exemplary purchase webpage for the system, enabling the user to provide billing and other account information, which can be stored in the customer database of FIG. 1.

FIG. 7 is an exemplary webpage arrived at by selecting the “Bottle Sponsor” option of the webpage of FIG. 2, depicting

FIG. 8 is an exemplary webpage displaying a list of clubs and bars within a selected location that have a guest list or VIP/bottle service on the selected date and is arrived at by selecting the “Guest List registration” option in FIG. 2.

FIG. 9 is an exemplary webpage where users enter their guest list information in order to be placed on the guest list of the desired club or bar and is arrived at by selecting the “GET ON THE LIST’ button for the desired club or bar on the webpage depicted in FIG. 8.

FIGS. 10a-b are exemplary web pages enabling authorized establishment personnel to input information about an establishment, which can be stored in the establishment database of FIG. 1.

FIG. 11 is an exemplary webpage for the start page of the “Affiliate Program” allowing current members to log in to their account and prospective members to select the type of membership to the program they desire.

FIG. 12 is an exemplary webpage arrived at by selecting the “Sign Up” option of the webpage of FIG. 10 and allows promoters to sign up for the “Affiliate Program” by inputting their information.

FIG. 13 is an exemplary webpage representing an affiliate member's home page in the “Affiliate Program” feature and is arrived at via the affiliate's account on the webpage of FIG. 10.

FIG. 14 is an exemplary webpage representing an authorized establishment personnel to input information about VIP/Guest List packages.

FIG. 15 is an exemplary webpage displaying a list of clubs and bars within a selected location that have a guest list or arrived at by selecting the “Guest List registration” option in FIG. 2.

### DETAILED DESCRIPTION OF THE PREFERRED EMBODIMENTS

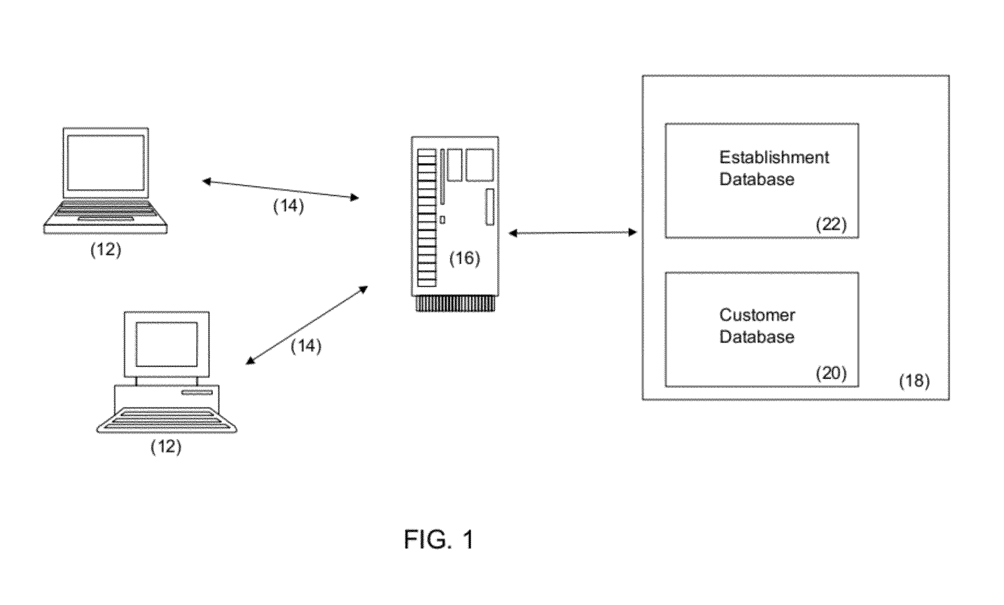

With reference now to the illustrative drawings, and particularly to FIG. 1, there is shown a simplified block diagram of a reservation system 10, which is contacted through client devices 12 via the Internet 14. The communication means between components are shown using a double-sided arrow, which may be a physical, fiber optic, wireless, or any other type of link. Additionally, other types of communications means and/or protocols can be used, for example, a customer can transfer information by means of a digital memory devices and memory readers, other means of information transfer now or in the future will be known in the art. Furthermore, even though four client devices and one scheduling center are depicted, any number can be used.

The reservation system 10 may be implemented using hardware, software, or a combination of the two.

A customer uses a client device 12 with software such as a web browser, commercially available examples of which are Netscape Navigator and Microsoft Internet Explorer, to access the Internet 14 or other link to communicate. The customer uses the web browser and Uniform Resource Locators (URLs) to locate the system's home page. The client device is illustrated as a personal computer (PC); however, the client device may be any other web-enabled device such as a portable device, a cellular telephone, laptop, and others.

A web server 16 runs applications for the web site and provides a means for connecting to the Internet 14. Multiple servers may be included in the web server 16 to accommodate for high volume accesses to the reservation system's web site. The application server stores the applications for the web site. The application server also runs applications that direct the data and information amongst the various components, modules, and servers of the reservation system.

The system further includes a data storage device 18 having a customer account database 20 and a nightclub database 22. The customer account database 20 stores the customer's personal information used, such as gender, billing information, and other information. The establishment database 22 stores information relating to the establishment and services provided, such as, location, bottle service packages, contact information, and other information.

Alternatively, it will be appreciated that combinations of the above data into different database configurations can be done in other embodiments of this invention. Additional information regarding these databases will be discussed throughout this description. The data stored in the data storage device 18 can be read, written, and executed by the various components, servers and modules included in the system.

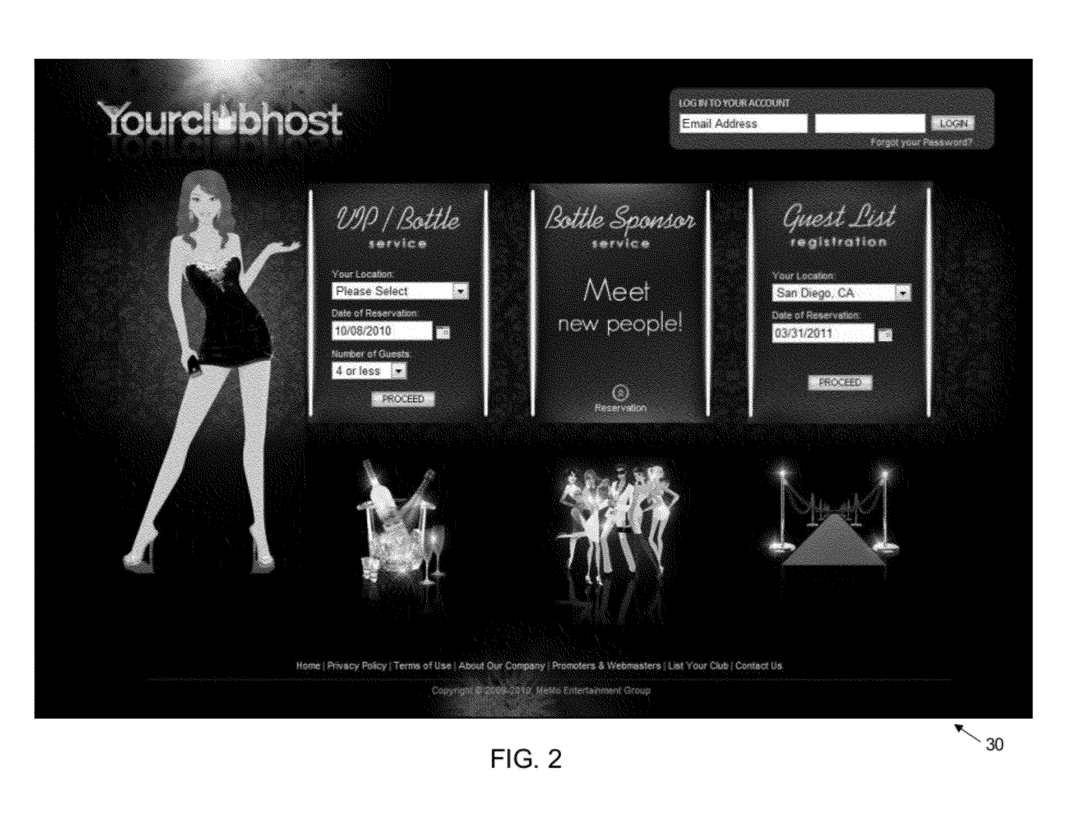

With reference now to FIG. 2, there is shown a webpage 30, displaying services provided by the system. Users can search for “VIP/Bottle Service” within a given location by clicking on the “VIP/Bottle Service” tab 32 and selecting a desired location, date of reservation, and the number of guests and selecting the “PROCEED” button in the “VIP/Bottle service” tab 32. Users can choose to search for bottle sponsors by clicking on the “Bottle Sponsor service” tab 34, selecting a desired location and date, and selecting the “PROCEED” button in the “Bottle Sponsor Service” tab 34. Users can also register on a club's guest list by clicking on the “Guest List registration” tab 36, selecting a desired location and date of reservation, and selecting “PROCEED” under the “Guest List Registration” tab 36.

Unless otherwise defined elsewhere, the term “bottle service” is intended to mean a service offered by an establishment in which a group of people purchase alcohol by the bottle for consumption on-site and typically includes a reserved seating area or table therein. The bottle service may further include admission and expedited entry into the establishment.

Upon selecting the “VIP/Bottle Service” tab 32, users are provided with the ability to conduct searches for bottle service based upon one or more parameters, such as location, date, number of guests, service features, seating location, and so on. The system can further propose and/or present packages to the user prior to, or without otherwise requiring, a search request. Such presented packages can be based on the user's reservation history, search history, profile details, and so on.

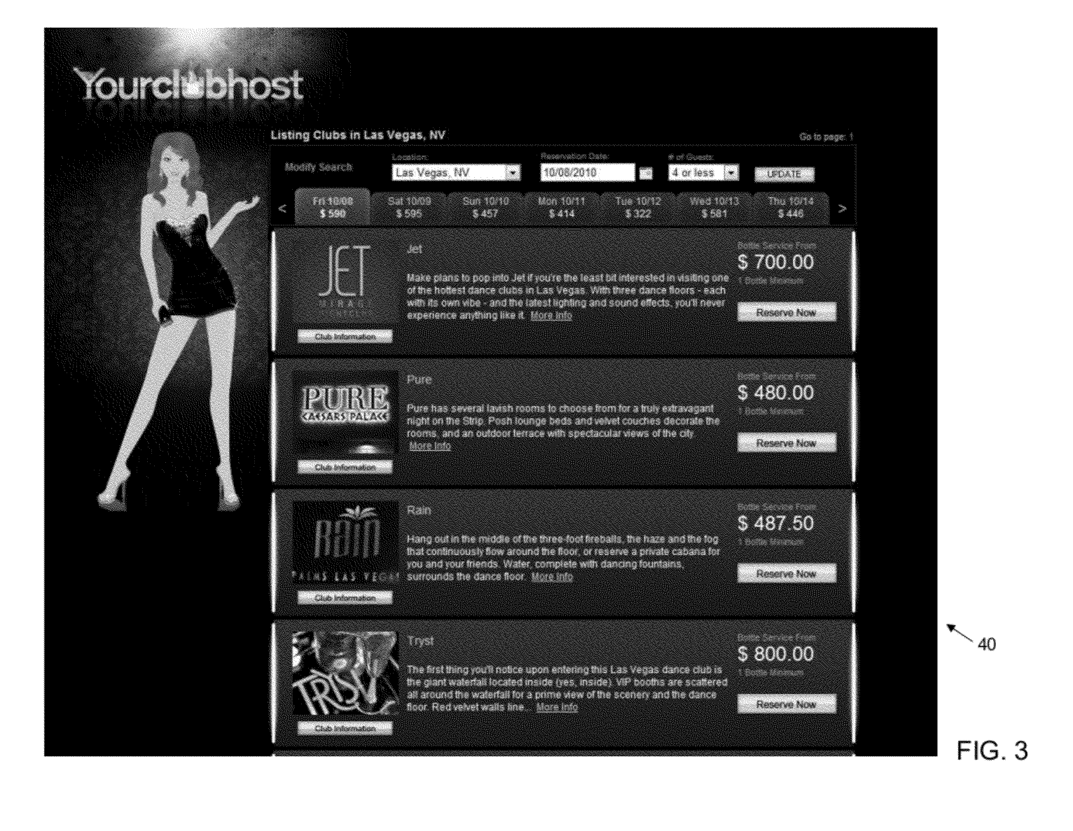

With reference now to FIG. 3, there is shown a webpage 40, providing results for an exemplary search for bottle service in a selected location on a particular date. In the exemplary embodiment, the user can search by location, reservation date, and number of guests. The results are provided below the search boxes. The results include details about the club, bottle service price, bottle minimums, among other things. Tabs 42 are provided that allow users to quickly access search results for other dates. The tabs 42 include pricing information for comparison. From this screen, the user can click the “Reserve Now” button to initiate the reservation process for particular nightclub. In addition, the user can access more information about the nightclub by selecting “more info” or “club information”.

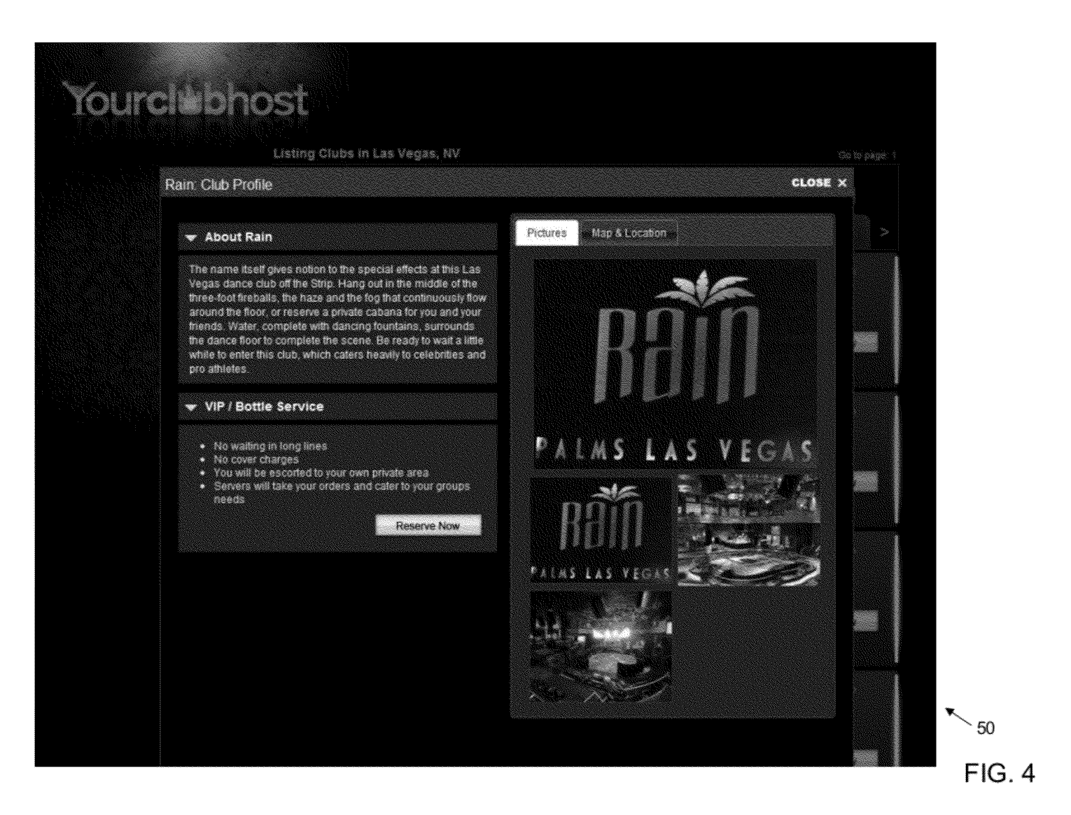

With reference now to FIG. 4, there is shown an exemplary webpage 50 providing detailed information for a particular nightclub in the “About” section 52 as well as particular information about the benefits of bottle service in selected club in the “VIP/Bottle Service” section 54. Photographs and location information are provided. Nightclub information can be loaded into the system by nightclub personnel and/or operators of the system. In selected embodiments, system users may be enabled to update information to include comments regarding the nightclub. The user can proceed to the reservation process by selecting the “Reserve Now” button 56.

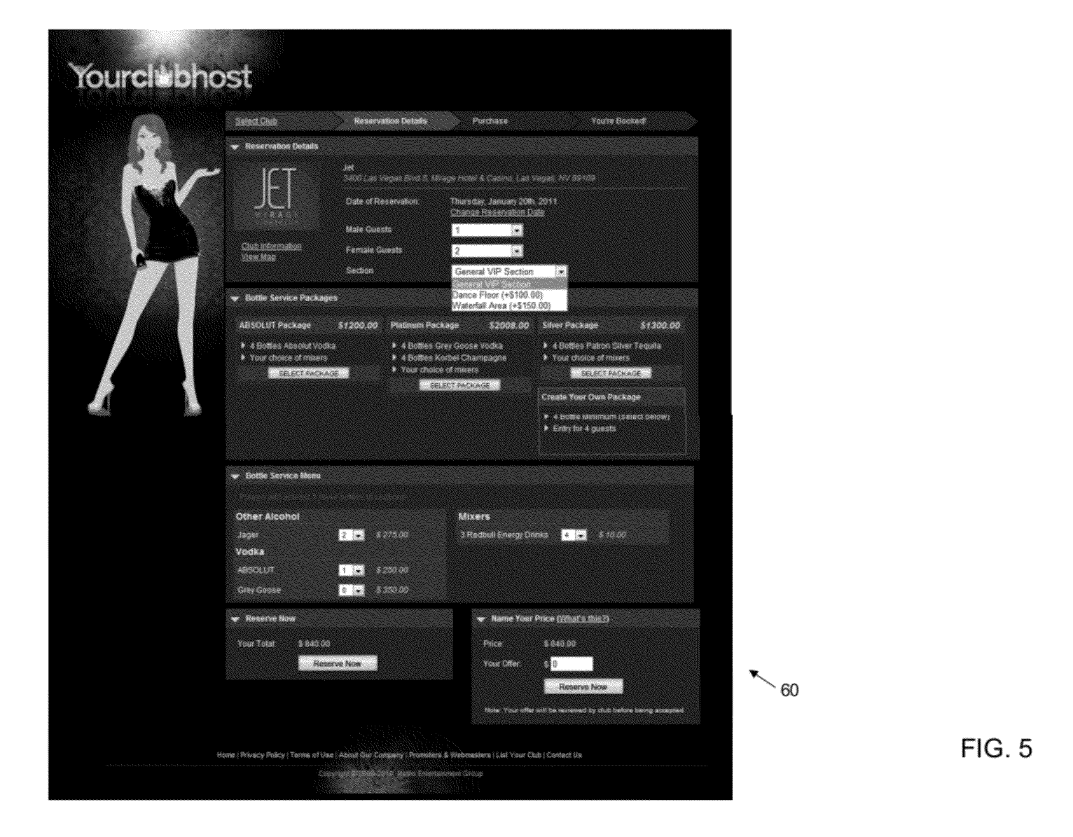

With reference now to FIG. 5, there is shown a webpage 60 where customers can provide reservation details and select a bottle service package and additional bottles and products for the particular nightclub they have selected. In the “Reservation Details” section 62 of the webpage, customers can set the date of the reservation, provide information on the number of male and female guests in their party, and select the table section they desire. In the “Bottle Service Packages” section 64, customers can select from a number a preset packages offered by the nightclub or they can create their own package per the minimum bottle and maximum guests specifications set forth by the club. In the “Bottle Service Menu” section 66 of the webpage, customers have the option to select from a number of additional bottles and products to add to the bottle service package they have selected. Once customers, provide their reservation details, select a bottle service package, and add any optional bottles or products to their order, they will have the option to accept the total price set forth by the club or to name their own price by making an offer. The customer can choose to accept the price offered by the club by selecting the “Reserve Now” button in the “Reserve Now” section of the webpage.

Alternatively, the customer can name their own price by inputting an offer and selecting “reserve now” in the “Name Your Price” section of the webpage. The offer will then be reviewed by the club who can accept or reject the offer.

Once a customer has decided which bottles to buy at a given club they are presented with an opportunity to specify a price they would like to pay rather than the full price. The customer can then submit the same offer to multiple clubs with one click. The system will notify each club selected of the offer by email, sms/text message, push notification or other method and ask them to accept or reject the offer. In the exemplary embodiment, the first nightclub to accept the offer will secure the reservation, and the user's credit card will be charged upon offer acceptance, securing the reservation.

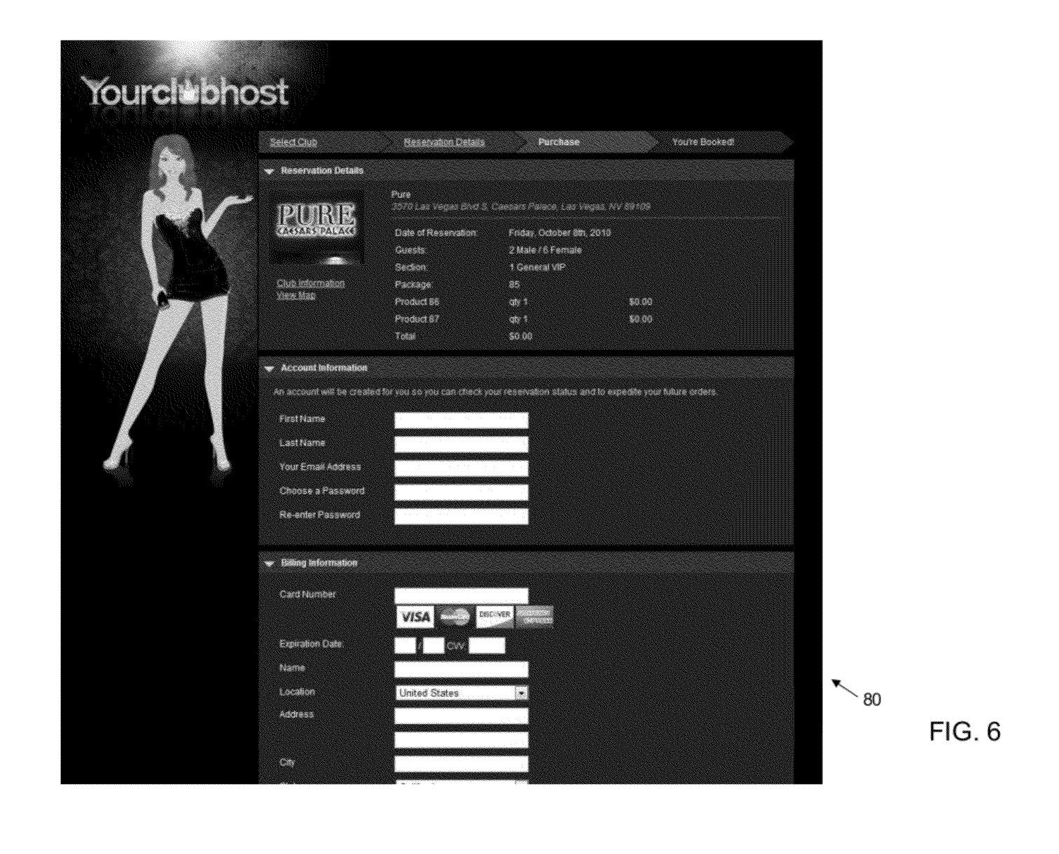

As shown in FIG. 6, once customers select their desired club, table section, bottle service package, additional bottles, and products, and provide details on the number of guests in their party, they will be directed to the purchase webpage 70 which will show all the reservation details. On this page, customers will be directed to create an account with the website and submit payment for the bottle service and products selected. In order to create an account, customers must provide a first and last name, email address, and an account password. Creation of a customer account allows the customer to check the status of all reservations under his/her account and expedites future orders through the website. Customers can pay for the bottle service and products by providing a credit card number as well as the name and billing address associated with the credit card number.

Customers will be assigned a rating based on their number of past orders, how much they spent, how often they purchased, the number of positive and negative experience reports for the customer from the clubs, the number of positive and negative energy reports for the customer from the clubs, the history of credit card charge backs or refunds, and other factors. This rating along with the last date the customer visited will be shared with clubs. Even if a customer is coming to a club for the first time, the club knows to give special treatment to highly rated customers.

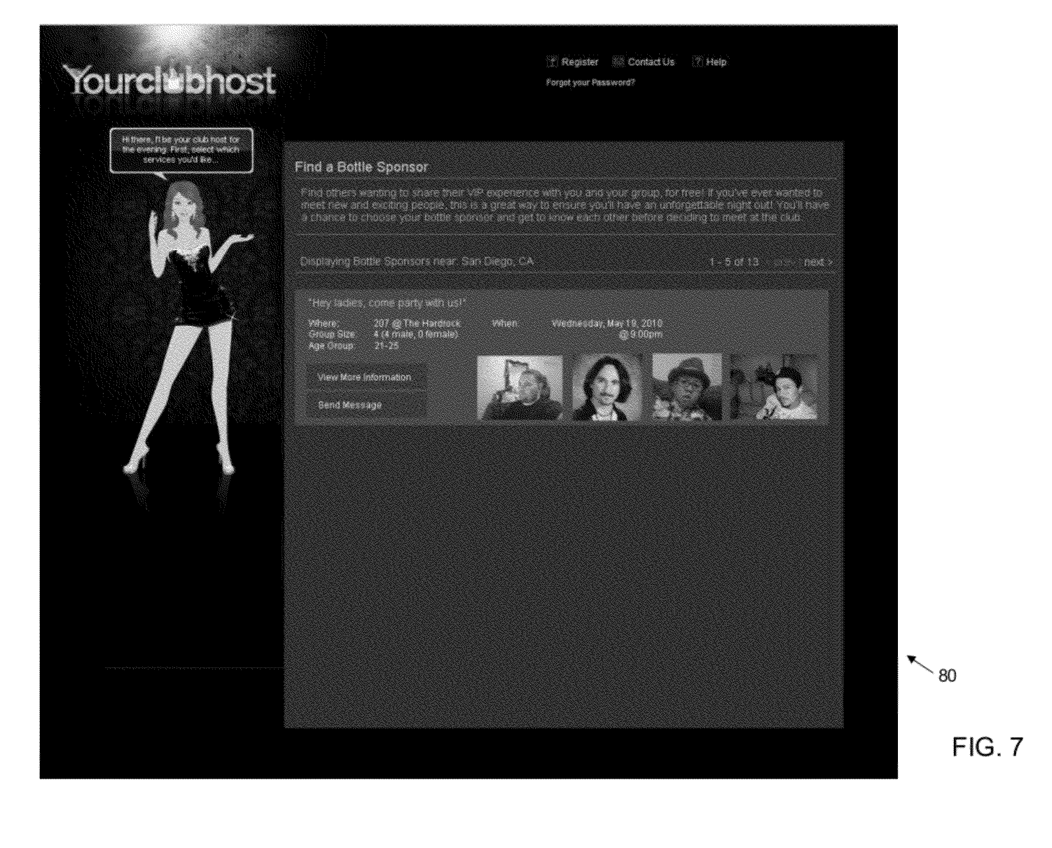

With reference now to FIG. 7, there is shown a webpage 80 displaying “Bottle Sponsors” within a selected location. Here, users can search for other users who would like to share the VIP experience. A list of all available “Bottle Sponsors” within a selected location will be listed. The results include a personalized message from the sponsoring party as well as detailed information about the sponsoring party, such as where and when they will be sponsoring the VIP bottle service, the size of the group (including the number of males and females), the party's age group, and pictures provided by the sponsoring group. Users can find out more information about the group by selecting “View More Information” or send the group a message by selecting “Send Message.”

Bottle Sponsorship enables visitors to meet customers who have purchased Bottle Service and are open to having another group join them. Customers can choose to invite others to join them for their reservation, i.e., “sponsor” the Bottle Service reservation. The sponsor can invite others free of charge or request that they contribute to the cost.

Bottle Service customers will be presented with the option to leave their reservation “open” to invite other groups of people to join them after their purchase has been made. If they agree, they will be asked to make a short “ad” describing their group, including optionally uploading photos of themselves. The sponsor can find interested groups to join them by viewing a list of other groups matching their search criteria (age, group size, location). Either the Bottle Sponsor or the interested groups can initiate contact via a messaging system. Either party can initiate a request for permission to join, or have a group join them. Users are not limited to only one request at a time, they may have multiple pending requests, however once a request is accepted all other pending requests immediately expire. Groups interested in finding a bottle sponsor will also be required to setup an “ad” in the same fashion as the Bottle Sponsor.

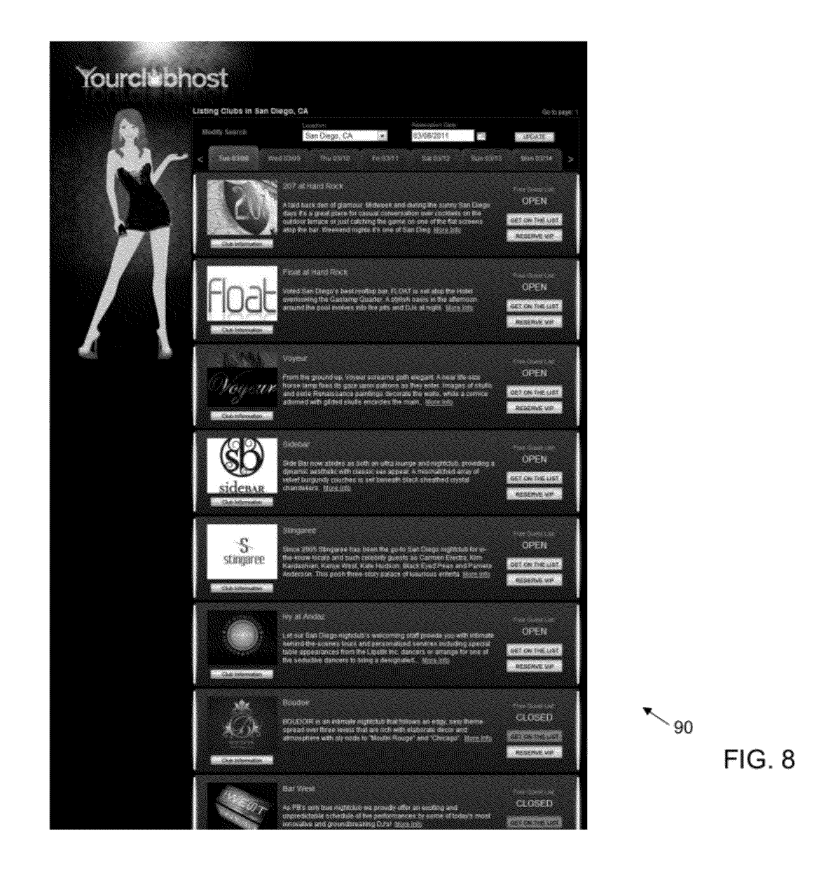

With reference now to FIG. 8, there is shown an exemplary webpage 90 displaying a list of clubs and bars within a selected location and on a selected date that have provide a guest list or VIP/bottle service. This webpage 90 is arrived at by selecting the “Guest List registration” option in the webpage 30 depicted in FIG. 2. On this page, users can view a short description for each listed club and bar and get on the guest list or reserve VIP service for the desired location.

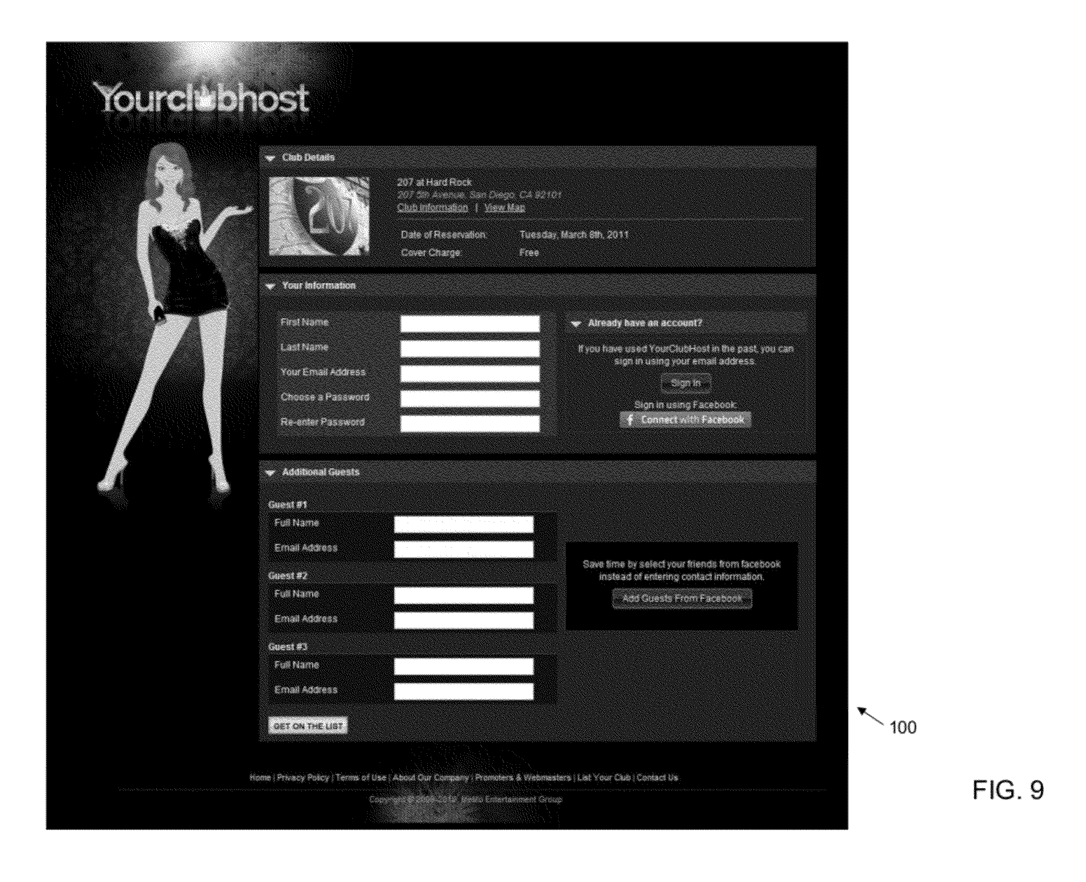

With reference now to FIG. 9, there is shown a webpage 100 where users can provide the names of the persons in their party in order to be put on the guest list for the particular nightclub or bar that has been selected. In an exemplary embodiment, users can be presented with the option of manually typing in each person's name or adding the guests through social networking sites (e.g., Facebook®) by selecting the person's profile. Once the names of the persons in the party have been entered on the webpage 100, the user then adds the names to the club's guest list by selecting the “GET ON THE LIST” button.

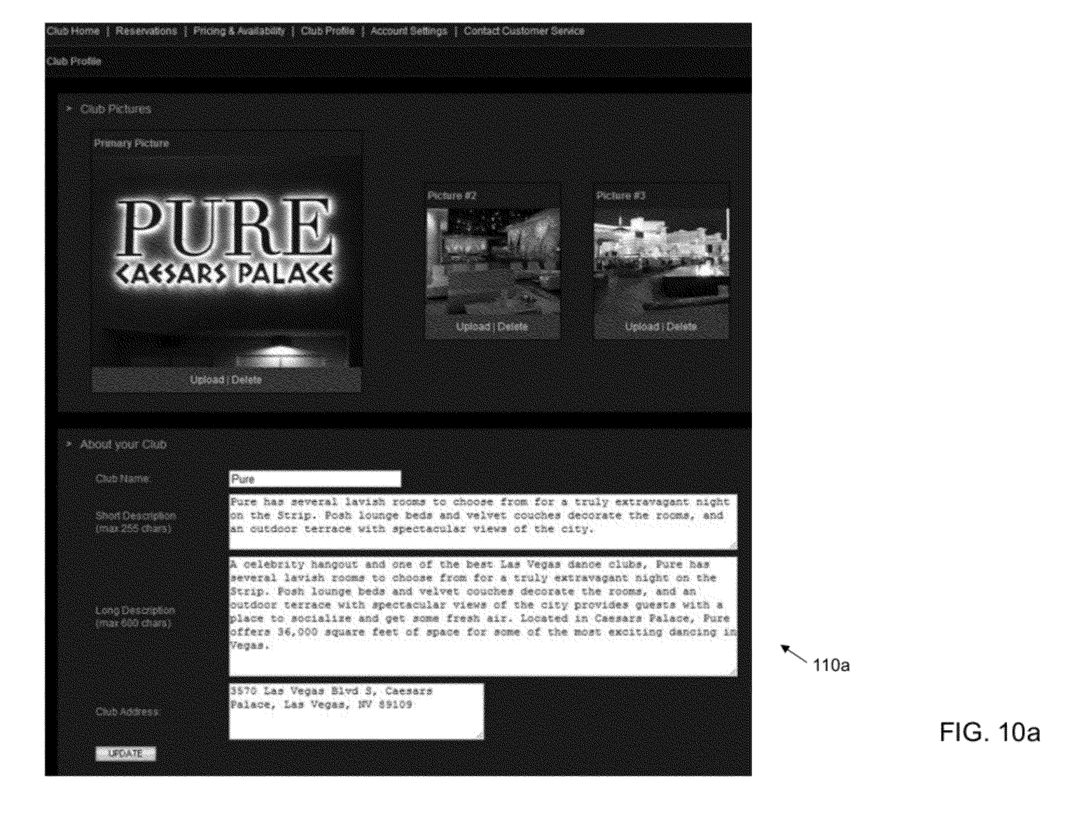

With reference now to FIGS. 10a-b, there are shown exemplary web pages 60a, 60b for providing and updating nightclub information for use by the reservation system 10. Access to these web pages can be limited to authorized personnel only. Authorized personnel can upload and/or delete photos, provide description information for the nightclub, and location information. The provided information is uploaded to the system by selecting the “UPDATE” button 112a.

Authorized personnel can provide information and prices for the various table sections and bottle service packages offered, as well as set a pricing and availability schedule for each day of the week. The authorized personnel can provide a listing of the table sections offered, a brief description of each section, the number of tables in each section, and any additional charges associated with each table section. They can also provide a list of the available bottle service packages together with a description and price of each package. Further, authorized personnel can provide a list of any additional bottles and products that can be purchased at the club, in addition to the bottle service package, together with a price for each additional bottle and product. Finally, the authorized personnel can set the prices and number of tables available in each table section for each day of the week. The prices for each bottle service package and additional bottles and products for each day can be set as a percentage of the list price provided earlier.

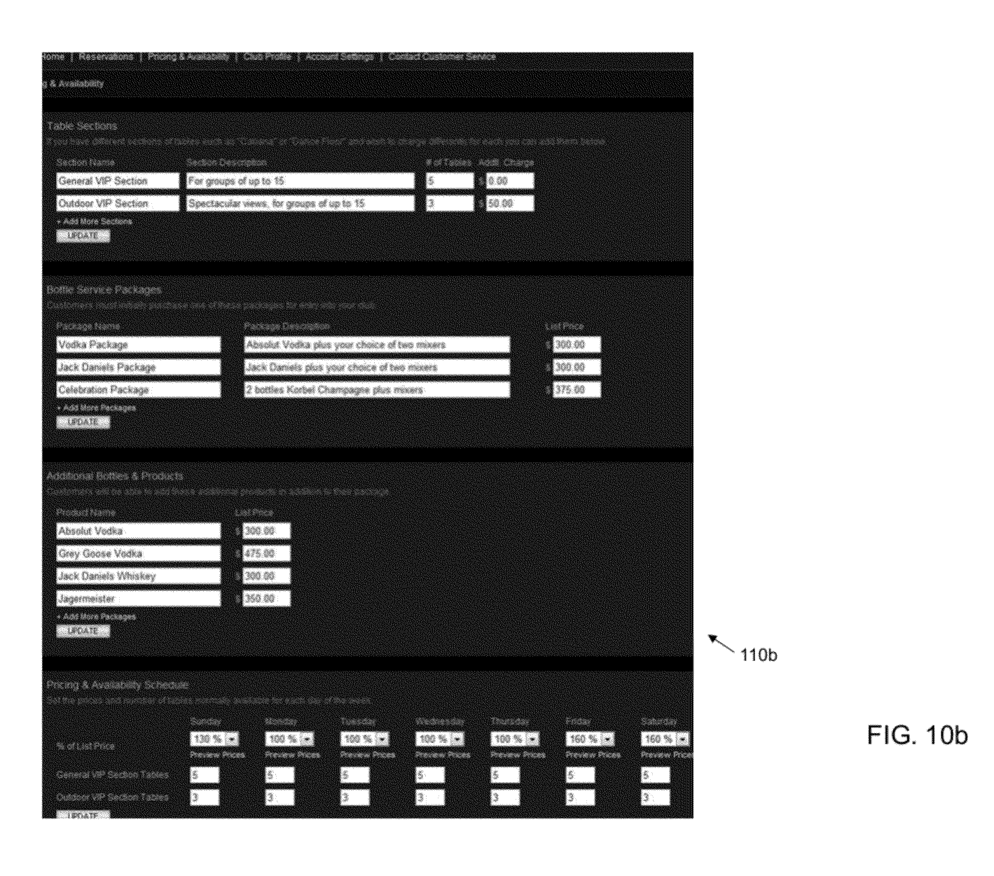

With reference now to FIG. 11, there is shown a webpage 120 displaying a webpage for the “Affiliate Program” where existing affiliate's can log-in to their individual account and new promoters can sign up to become affiliate's. The system is configured so that operators can enable third-party users, or affiliates, to direct potential customer to the services of the reservation system, e.g., via links from other websites, electronic newsletters, or blogs among others. In exchange, the affiliate can earn a portion of the revenue generated, for any referred person or entity.

Unique links are provided to the affiliate for use in their advertising, (webpage links, embedded links in electronic newsletters, or blogs). In addition to a unique link, affiliates will receive a unique ID number that is provided to their customers that can be used in lieu of the link. The system can identify the visitors via these links or unique ID numbers and associate them to a particular affiliate as the referral source. The system can further limit the duration for completing a purchase for payment of a commission. In an exemplary embodiment, the system can set the purchase deadline as forty-five (45) days for the referred visitor to complete their purchase in order for the referring affiliate to qualify for a commission. In the exemplary embodiment, affiliates receive commission payments for completed purchases.

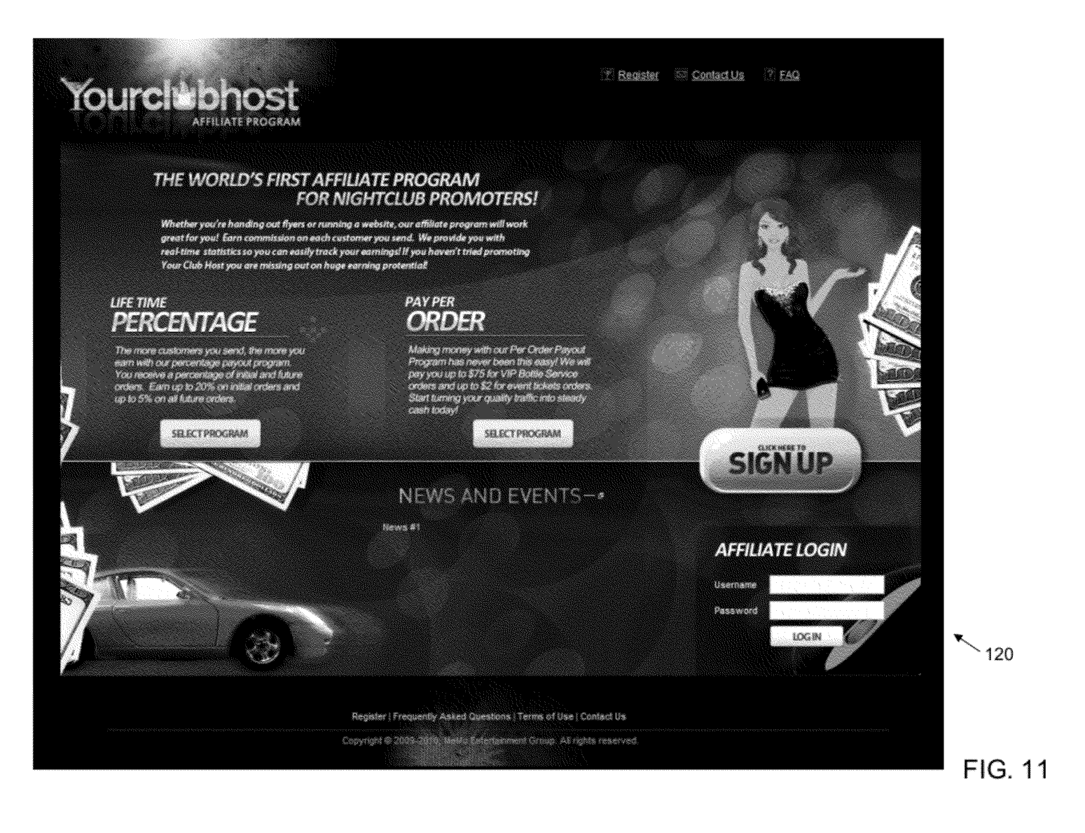

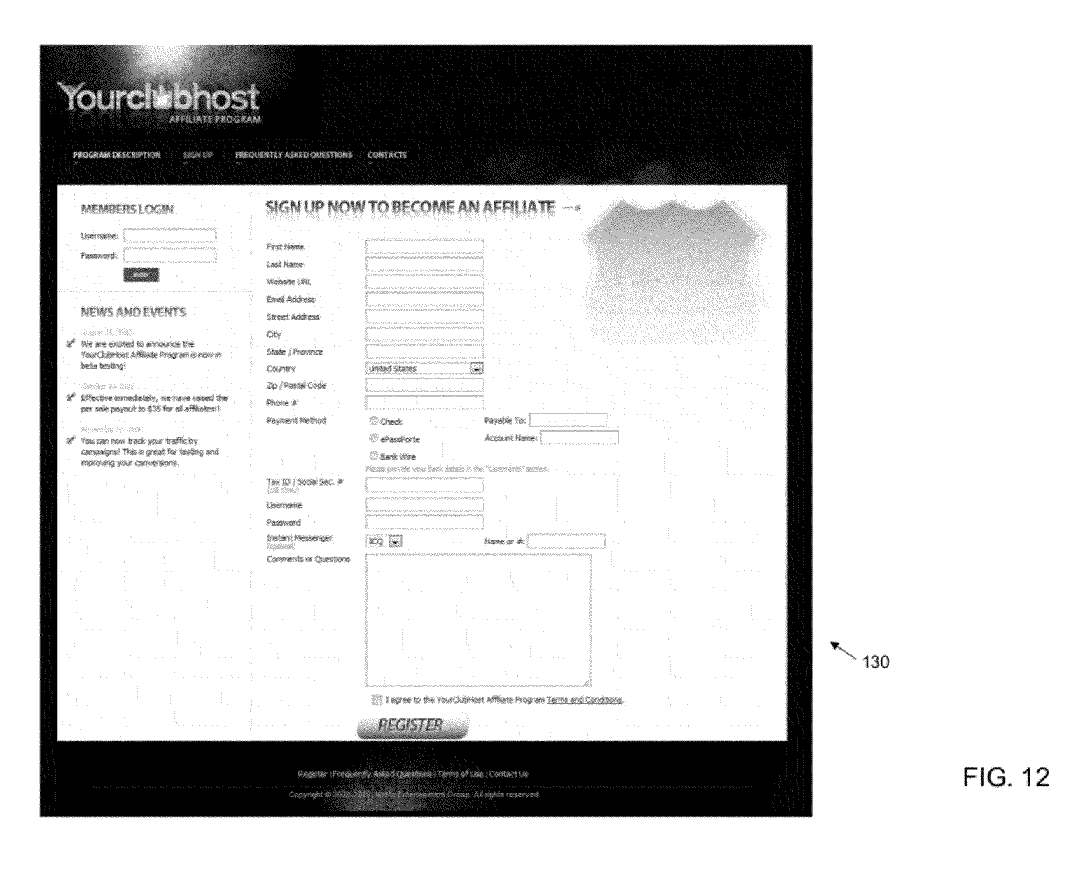

With reference now to FIG. 12, there is shown an With reference now to FIG. 13 where new affiliates can sign up for the “Affiliate Program” by submitting their personal information and preferred method of payment.

With reference now to FIG. 13, there is shown an exemplary webpage 140 displaying an affiliate member's home page within the “Affiliate Program.” On this page, the member can review individual account information, billing information, and payout amounts as well as the member's marketing tools and statistics.

The reservation service will also enable customers to purchase drink tickets or bottles in advance at a discount. Consumers can buy their drink/bottle tickets before going to the club at a savings. Drink tickets will have unique numbers that correspond with a list that the club has to verify authenticity.

Customers are able to select celebrities to join them as part of their bottle service experience for an additional fee. This service is also available to clubs who would like to bring a recognizable celebrity to their club.

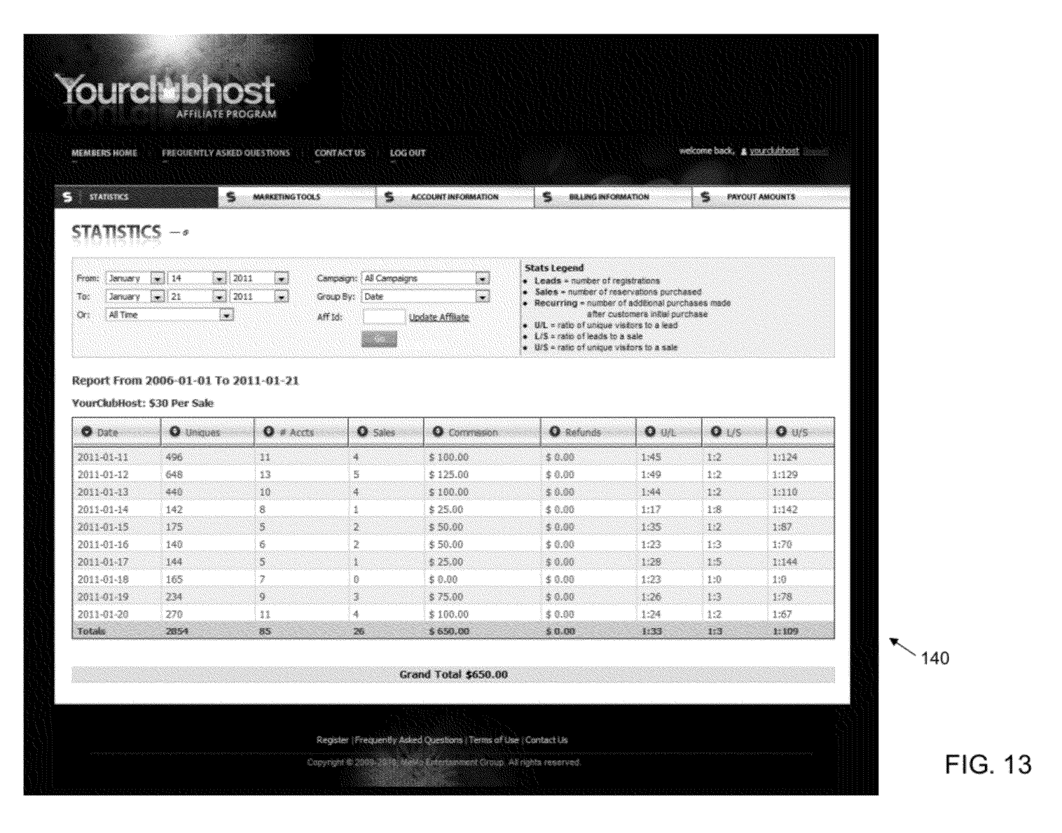

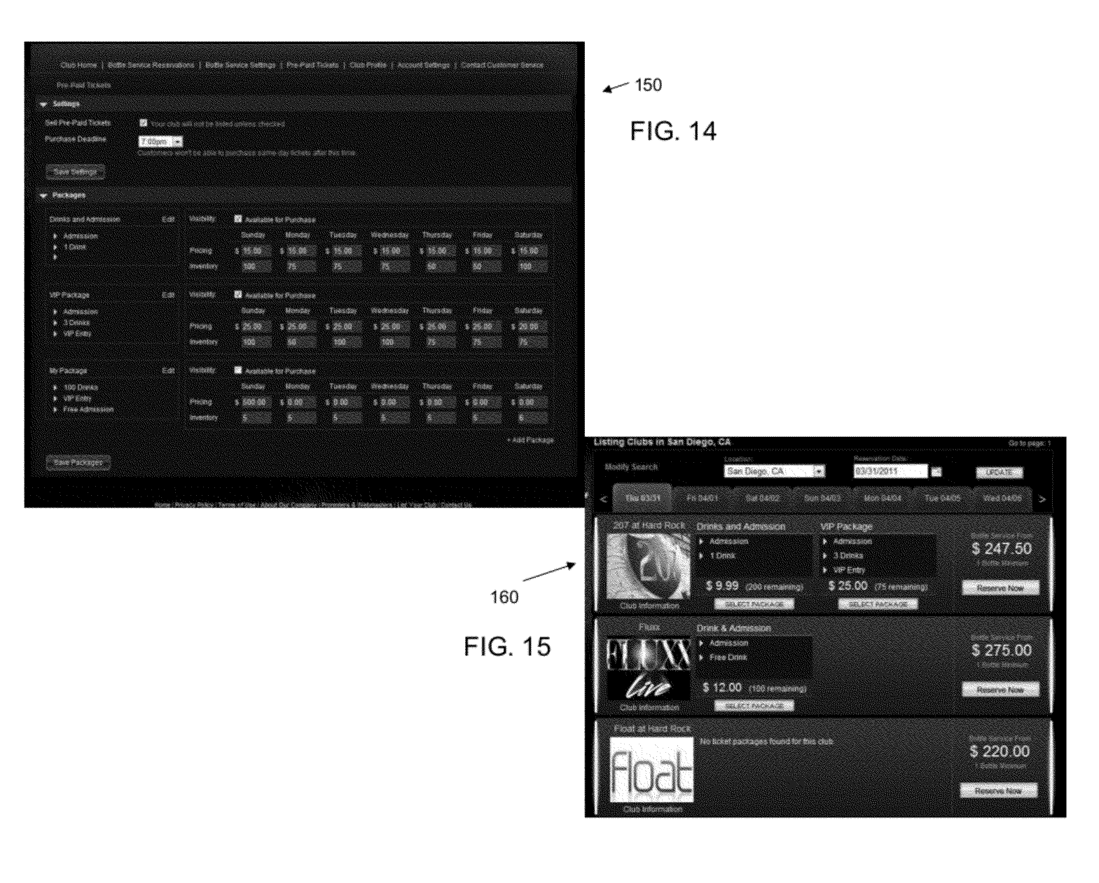

With reference now to FIGS. 14 and 15, exemplary webpages 150 and 160 are shown. Webpage 150 enables authorized personnel for the establishment to set information and prices regarding admission and pre-purchase of for drink (e.g., via drink tickets) in various packages, as well as set a pricing, and number of packages available for each day of the week. The authorized personnel can provide several different packages, a brief description of each package, and can turn the packages on or off via the “visibility” feature. Webpage 160 is an exemplary listing of clubs and bars within a selected location arrived at by selecting the “Guest List registration” option in FIG. 2. The list displays packages set by the establishment, e.g., via the input functionality of the system such as those discussed with reference to FIG. 14.

The present invention has been described above in terms of presently preferred embodiments so that an understanding of the present invention can be conveyed. However, there are other embodiments not specifically described herein for which the present invention is applicable. Therefore, the present invention should not to be seen as limited to the forms shown, which is to be considered illustrative rather than restrictive.

What is claimed is:

1. In a computer-based reservation system, a computerized method for event reservation such as bottle service at nightclubs, comprising:
presenting to a user via digital communications with a client device, a listing of nightclubs in response to a reservation search received from the user,
the reservation search including location and date, and
the listing of nightclubs including nightclubs within the requested location having availability on the requested date and pricing for bottle service, the listing including the ability for the user to select a nightclub from the list to secure a reservation; and
reserving a bottle-service reservation for the user at a selected nightclub based upon terms to include date, price, and a bottle minimum, agreed upon by the user and the selected nightclub, in which reservation details are transmitted to the user and the selected nightclub via digital communications.

2. A method as defined in claim 1, wherein the reservation request includes data representing number of guests, a bottle minimum, and seating location preference.

3. A method as defined in claim 1, wherein reserving step further includes:
enabling the user to transmit to multiple nightclubs simultaneously an offer to reserve bottle service on prescribed date at a price set by the user, and securing a reservation for the user at the nightclub that first accepts the user's offer.

4. A method as defined in claim 3, wherein the offer further includes number of guests and a bottle minimum.

5. A method as defined in claim 4, wherein the user is charged for the reservation upon acceptance the offer.

6. A method as defined in claim 1, wherein a rating of the user is provided to the nightclub in conjunction with a reservation offer, the rating determined based upon on number of prior reservations of the user, spending of the user, and frequency of reservations.

7. A method as defined in claim 1, further comprising enabling the user electronically post an invitation for other users to join the bottle service reservation.

8. A method as defined in claim 1, further comprising enabling the user to book a celebrity from a listing of celebrities presented the user on the client device to attend the bottle-service reservation of the user.

9. A computer-readable medium having computer-executable instructions for performing a method for event reservation such as bottle service at nightclubs, the instructions comprising:
presenting to a user via digital communications with a client device, a listing of nightclubs in response to a reservation search received from the user,
the reservation search including location and date, and
the listing of nightclubs including nightclubs within the requested location having availability on the requested date and pricing for bottle service, the listing including the ability for the user to select a nightclub from the list to secure a reservation; and
reserving a bottle-service reservation for the user at a selected nightclub based upon terms to include date, price, and a bottle minimum, agreed upon by the user and the selected nightclub, in which reservation details are transmitted to the user and the selected nightclub via digital communications.

10. A computer-readable medium as recited in claim 9, wherein the reservation request includes data representing number of guests, a bottle minimum, and seating location preference.

11. A computer-readable medium as recited in claim 9, wherein reserving step further includes:
enabling the user to transmit to multiple nightclubs simultaneously an offer to reserve bottle service on prescribed date at a price set by the user, and
securing a reservation for the user at the nightclub that first accepts the user's offer.

12. A computer-readable medium as recited in claim 11, wherein the offer further includes number of guests and a bottle minimum.

13. A computer-readable medium as recited in claim 12, wherein the user is charged for the reservation upon acceptance the offer.

14. A computer-readable medium as recited in claim 9, wherein a rating of the user is provided to the nightclub in conjunction with a reservation offer, the rating determined based upon on number of prior reservations of the user, spending of the user, and frequency of reservations.

15. In a computer-based reservation system, a computerized method for event reservation such as bottle service at nightclubs, comprising:
presenting to a user via digital communications with a client device, a listing of nightclubs in response to a reservation search received from the user,
the reservation search including location and date, and
the listing of nightclubs including nightclubs within the requested location having availability on the requested date and pricing for bottle service, the listing including the ability for the user to select a nightclub from the list to secure a bottle-service reservation; and
reserving a bottle-service reservation for the user at a selected nightclub based upon terms to include date, price, and a bottle minimum, agreed upon by the user and the selected nightclub, in which reservation details are transmitted to the user and the selected nightclub via digital communications.
